(19) United States
(12) Patent Application Publication
(10) Pub. No.: US 2004/0213708 A1
(43) Pub. Date: Oct. 28, 2004

(54) Exhaust-treatment core apparatus and method of making

(76) Inventors: Wayne M Wagner, Apple Valley, MN (US); Gary D Reeves, Lakeville, MN (US)

Correspondence Address: MERCHANT & GOULD PC, P.O. BOX 2903, MINNEAPOLIS, MN, 55402-0903, US

(21) Appl. No.: 10/493,753

(22) PCT Filed: Oct. 25, 2002
(86) PCT No.: PCT/US02/34520

Related U.S. Application Data
(60) Provisional application No. 60/345,870, filed on Oct. 26, 2001.

(51) Int. Cl. B01D 53/34

(52) U.S. Cl. 422/180; 422/177; 422/179

(57) ABSTRACT

The present disclosure relates to a method for making an exhaust treatment device having a substrate (22) positioned within a casing (24). The casing includes a primary wall (26) that surrounds the substrate (22) and end flanges (28) that extend inwardly from the primary wall (26). The end flanges (28) oppose ends of the substrate and assist in retaining the substrate within the casing. The method includes providing the casing (24) with the flanges (28). The method also includes positioning the substrate within the casing after casing has been provided with the flanges. A device having a bead structure (43) positioned between a casing (24) and an exhaust structure (27) is also disclosed.

This application is being filed as a PCT international patent application in the name of Donaldson Company, Inc., a U.S. national corporation (applicant for all designations except the U.S.), and in the names of Wayne M. Wagner and Gary D. Reeves, both U.S. citizens and residents (applicants for the U.S. designation only), on 25 Oct. 2002, designating all countries.

### FIELD OF THE INVENTION

The present invention relates generally to exhaust treatment devices having cores such as catalytic converters or diesel particulate filters.

### BACKGROUND OF THE INVENTION

To reduce air pollution, vehicle emissions standards have become increasingly more stringent. With respect to both internal combustion and diesel engines, catalytic converters have been used to reduce the concentration of pollutant gases (e.g., hydrocarbons, carbon monoxide, nitric oxide, etc.) in the exhaust stream. Also, with respect to diesel engines, diesel particulate filters have been used to reduce the concentration of particulate matter (e.g., soot) in the exhaust stream.

A typical catalytic converter includes a substrate mounted in an outer casing or “can.” The substrate defines a plurality of longitudinal channels that extend through the catalytic converter. Exemplary substrate materials include ceramic (e.g., extruded magnesia alumina silicate) and corrugated metal (e.g., stainless steel). A catalyst is provided on the substrate for promoting the oxidation of a gaseous pollutant. For example, the catalyst can include a precious metal such as platinum, palladium or rhodium, a base metal or a material such as zeolite. In some cases, a material such as zeolite can be included as both a substrate and a catalyst.

A typical diesel particulate filter includes a ceramic substrate mounted in an outer casing. The ceramic substrate is porous and defines a plurality of longitudinal channels. Adjacent longitudinal channels are plugged at opposite ends of the core as described in U.S. Pat. No. 4,851,015 that is hereby incorporated by reference in its entirety. The plugged ends forces exhaust gases to flow through the walls of the substrate so that soot is collected on the walls as the gases pass therethrough. For some applications, a catalyst can be provided on the substrate such that the filter functions like a catalytic converter to reduce the concentration of pollutant gases.

The diesel particulate filter described in the '015 patent includes a substrate enclosed within an outer casing. End gaskets are also located within the casing. The casing includes end flanges for retaining the substrate and end gaskets within the interior of the casing. The flanges are manufactured through a die forming process that forms the flanges by compressing the ends of the casing against the substrate. Often the size of the substrate is not precisely toleranced so as to match the forming die. For example, the die is often “round” (i.e. cylindrical) while substrates can often be slightly “out of round” (i.e., slightly oval). When an “out of round” substrate is compressed within a “round” die to form the end flanges, compression forces within the substrate can cause the substrate to fracture. This is particularly problematic for substrates such as thin walled substrates and zeolite catalyst substrates, which are often considerably more fragile than conventional ceramic substrates.

### SUMMARY OF THE INVENTION

One aspect of the present invention relates to a method for making an exhaust treatment device having a substrate positioned within a casing. The casing includes a primary wall that surrounds the substrate and end flanges that extend inwardly from the primary wall. The end flanges oppose ends of the substrate and assist in retaining the substrate within the casing. The method includes providing the casing with the flanges. The method also includes positioning the substrate within the casing after casing has been provided with the flanges. To prevent fracturing of the substrate, the flanges are made prior to insertion of the substrate core.

A variety of other aspects of the invention are set forth in part in the description that follows, and in part will be apparent from the description, or may be learned by practicing the invention. The aspects of the invention relate to individual features as well as combinations of features. It is to be understood that both the foregoing general description and the following detailed description are exemplary and explanatory only and are not restrictive of the invention as claimed.

### BRIEF DESCRIPTION OF THE DRAWINGS

FIG. 1 shows an exhaust treatment device constructed from a method in accordance with the principles of the present invention;

FIG. 1A is a detailed view of a portion of the device of FIG. 1A;

FIG. 1B is a detailed view of a sealing bead of the device of FIG. 1A;

FIG. 2 is a perspective view of a muffler body having features that are examples of how inventive aspects in accordance with the principles of the present disclosure can be put into practice;

FIG. 3 is a cross-sectional view of the muffler body of FIG. 2 taken along a section plane that longitudinally bisects the muffler body;

FIG. 3A is a detailed view of a portion of FIG. 3;

FIG. 4 is a laid-flat, plan view of a casing of the device of FIG. 1;

FIG. 5A is an end view of a roller configuration for forming the casing of the device of FIG. 1;

FIG. 5B is a cross-sectional view taken along section line 5B-5B of FIG. 5A;

FIG. 6 is a perspective view of the casing of the device of FIG. 1;

FIG. 7 is an end view of the casing of FIG. 6 with the casing expanded to an open position so as to receive a substrate therein;

FIG. 8A is a cross-sectional view of the device of FIG. 1 showing the casing including a lap joint;

FIG. 8B is a cross-sectional view of the device of FIG. 1 showing the casing including a butt joint;

FIG. 9 shows another roller configuration for forming the device of FIG. 1;

FIGS. 10A and 10B show another configuration for forming the device of FIG. 1;

FIG. 10C shows another configuration for forming the device of FIG. 1;

FIG. 10D shows another configuration for forming the device of FIG. 1;

FIG. 10E shows another configuration for forming the device of FIG. 1;

FIG. 11 is a laid-flat, plan view of an alternative casing having features that are examples of how inventive aspects in accordance with the present disclosure can be put into practice;

FIG. 12 is an elevational view of the casing of FIG. 11 after having been formed to its desired shape;

FIG. 13 is a top, end view of the casing of FIG. 12;

FIG. 14 is a cross-sectional view taken along section-line 14-14 of FIG. 13;

FIG. 15 is a cross-sectional view taken along section-line 15-15 of FIG. 12;

FIG. 16 is an end view of the casing of FIGS. 11-15 shown flexed partially open;

FIG. 17 is a perspective view of the casing of FIG. 16;

FIG. 18 is a laid-flat, plan view of an alternative casing having features that are examples of how inventive aspects in accordance with the present disclosure can be put into practice;

FIG. 19 is an elevational view of the casing of FIG. 18 after having been formed to its desired shape;

FIG. 20 is a top, end view of the casing of FIG. 19;

FIG. 21 is a cross-sectional view taken along section-line 21-21 of FIG. 20; and

FIG. 22 is a cross-sectional view taken along section-line 22-22 of FIG. 19.

While the invention is amenable to various modifications and alternative forms, specifics thereof have been shown by way of example in the drawings and will be described in detail below. It is to be understood, however, that the intention is not to limit the invention to the particular embodiments described. On the contrary, the invention is intended to cover all modifications, equivalents, and alternatives falling within the scope of the invention as defined by the appended claims.

### DETAILED DESCRIPTION

In the following detailed description, references are made to the accompanying drawings that depict various embodiments in which the invention may be practiced. It is to be understood that other embodiments may be utilized, and structural and functional changes may be made without departing from the scope of the present invention.

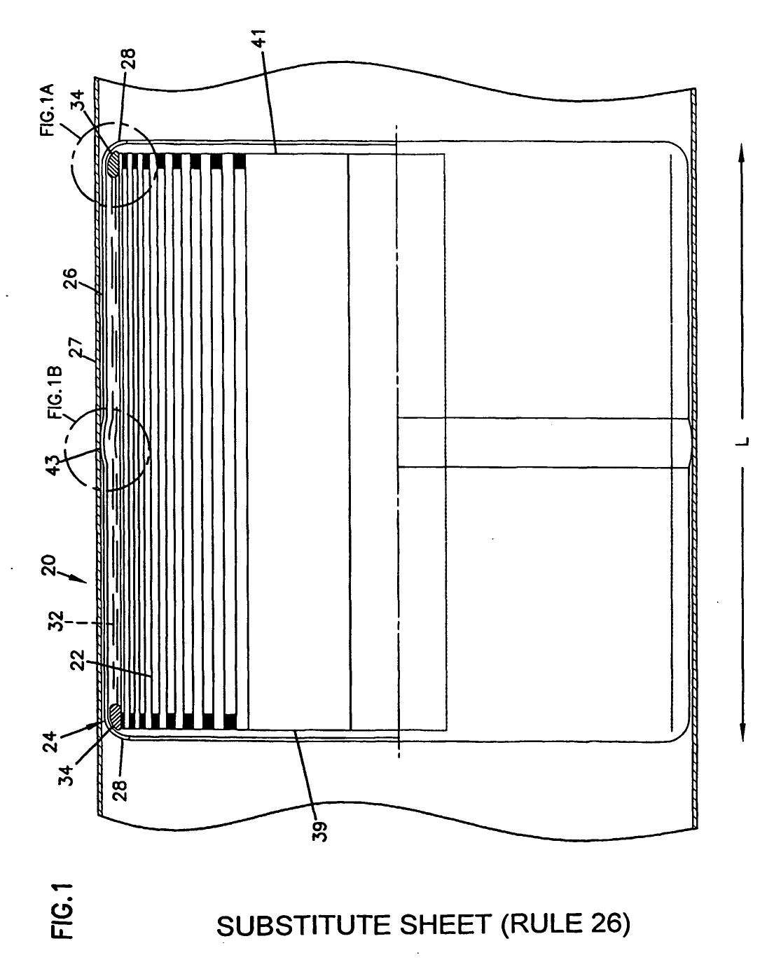

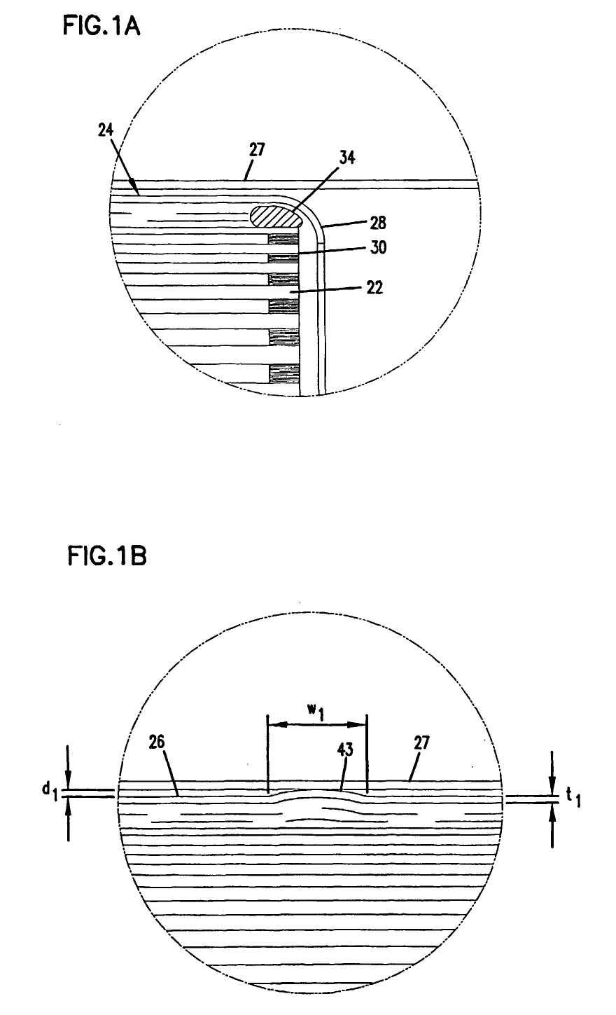

FIG. 1 illustrates an exhaust treatment device 20 made in accordance with the principles of the present invention. The device 20 includes a substrate 22 positioned within a casing 24. The casing 24 includes a primary wall 26 and end flanges 28 that project radially inwardly from the primary wall 26. The end flanges 28 oppose (i.e., overlap) opposite end faces 39, 41 of the substrate 22 and assist in retaining the substrate 22 within the casing 24. Preferably, the end flanges 28 are generally perpendicular with respect to the primary wall 26. However, in other embodiments, the end flanges 28 can be aligned at angles other that right angles relative to the primary wall 26. The exhaust treatment device 20 is adapted to be mounted in an exhaust system component such as a muffler body 27 (only a portion of which is shown).

Referring still to FIG. 1, a heat resistant/cushioning layer 32 is positioned between the primary wall 26 and the substrate 22. Sealing members 34 (e.g., compressible braided ropes of fiberglass) are mounted around the ends of the substrate adjacent the flanges 28. One of the sealing members 34 is best shown in FIG. 1A.

As shown in FIG. 1, the casing 24 has a length L that is slightly longer than the distance between the end faces 39, 41 of the substrate 22. The casing 24 also includes an optional bead structure 43 (shown enlarged at FIG. 1B) that projects radially outwardly from the primary wall 26 and extends about the perimeter/circumference of the exhaust treatment device 20. The bead structure can be used to size the casing 24 within the muffler body 27, and/or to provide a circumferential seal between the casing 24 and the muffler body 27. In the case of a circumferential seal, the bead structure 43 preferably extends continuously about the entire circumference of the casing 24. For sizing purposes, it may be desirable to include a bead structure having a plurality of discrete/non-continuous bead segments arranged about the circumference of the casing 24. In other embodiments, more than one bead structures can be provided on the exterior of the casing 24. For example, separate bead structures 43 can be located adjacent each end of the device.

Referring to FIG. 1B, the bead structure 43 preferably has a dimension w1 in the L direction that is less than 1 inch. In other embodiments, the dimension w1 can be in the range of 0.5-2 inches, or in the range of 0.75-1 inch. Still referring to FIG. 1B, the bead structure 43 can have a dimension d1 that is 0.5 to 2 times as large a thickness t1 of the casing 24. In other embodiments, the dimension d1 is 0.75 to 1.25 times as large as the thickness t1. In further embodiments, the dimension d1 is in the range of 0.025-0.080 inch, or 0.035-0.060 inch, or about 0.047 inch.

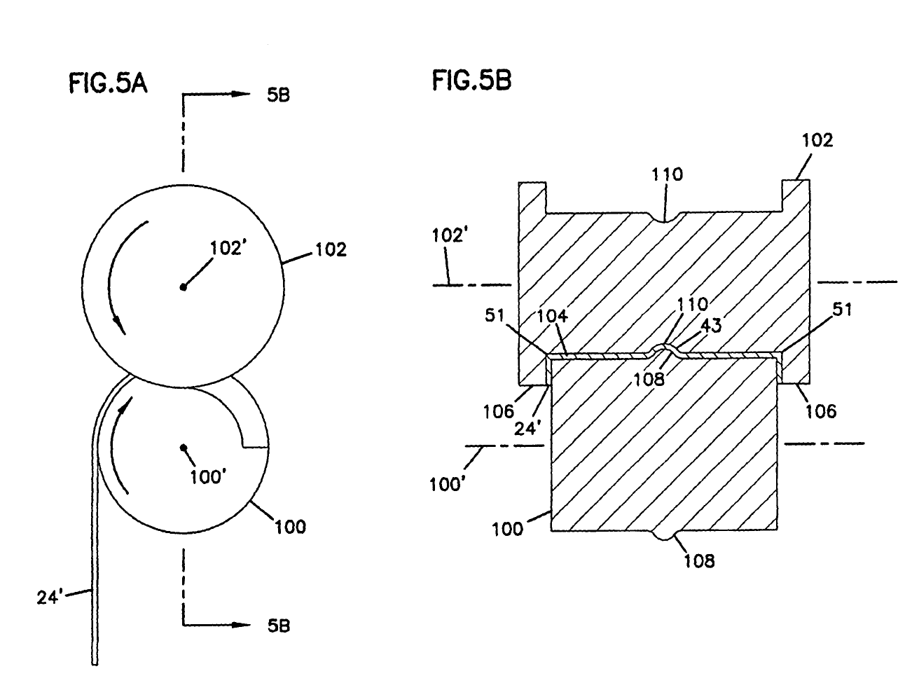

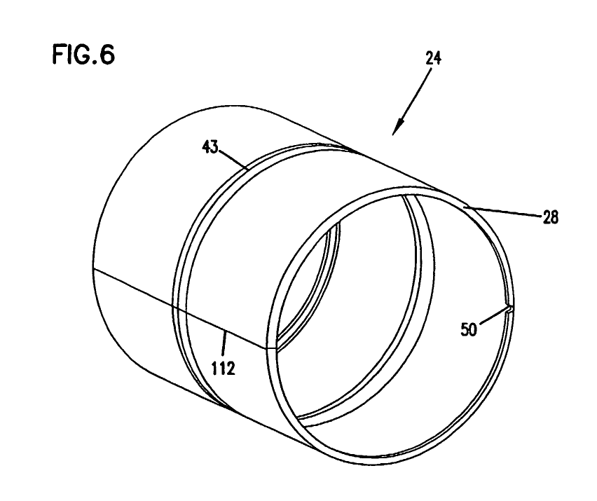

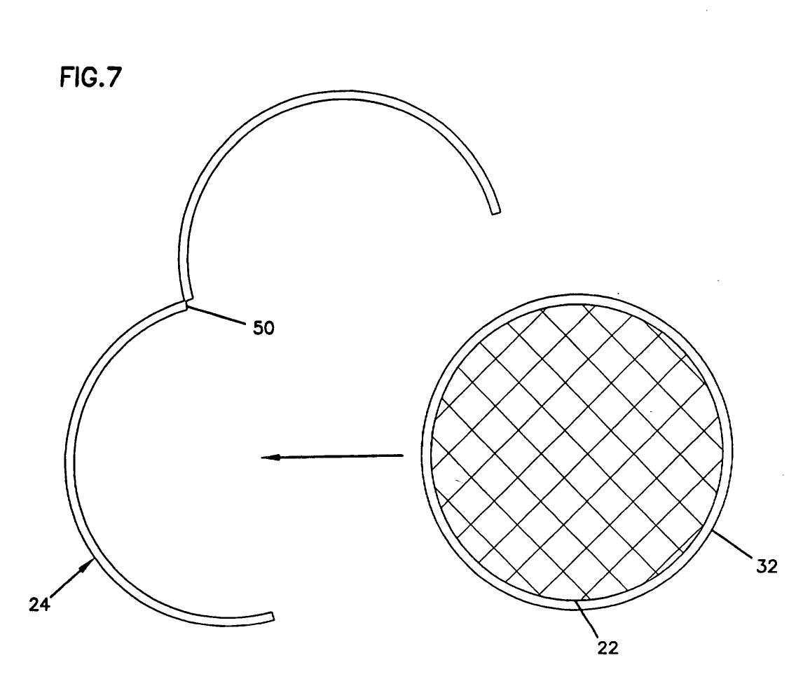

The substrate 22 of the device 20 can have a variety of configurations. For example, the substrate can be a cellular ceramic core (e.g., extruded magnesia alumina silicate) having longitudinal channels that extend at least partially therethrough. An exemplary ceramic substrate for a diesel particulate filter is described in U.S. Pat. No. 4,851,015, which is hereby incorporated by reference. Similar ceramic substrates having channels that extend completely therethrough can be used for catalytic converters. The substrate 22 can also be a corrugated metal substrate (i.e., a “foil” substrate) of the type shown in FIG. 7 of U.S. Pat. No. 5,355,973, which is hereby incorporated by reference in its entirety. The substrate 22 can further be made of a material such as zeolite. Other materials include alumina, zirconia, titania, lanthana, silica dioxide, silicon carbide as well as other materials and mixtures thereof.

The substrate 22 preferably includes a catalyst. For example, the substrate can be made of a catalyst, impregnated with a catalyst, mixed with a catalyst or coated with a catalyst. Exemplary categories of catalysts include oxidation catalysts such as carbon monoxide (CO) catalysts and hydrocarbon (HC) catalysts, and reduction catalysts such as lean NOx (nitric oxide) catalysts and selective catalytic reduction (SCR) catalysts. Exemplary catalysts include precious metal catalysts such as platinum, palladium or rhodium, or other types of catalysts such as vanadium, base metals or zeolites.

The casing 24 of the device 20 is preferably a metallic material such as aluminized steel or stainless steel. In one embodiment, the casing has an 18-gauge thickness. In different embodiments, the primary wall 26 of the casing can have different transverse cross-sections. For example, the primary wall 26 can have a round transverse cross-section or an oval transverse cross-section.

The heat resistant/cushioning layer 32 of the device 20 is preferably an intumescent layer that expands when heated. An exemplary method for mounting such a layer about a substrate is disclosed in U.S. Pat. No. 4,851,015 that was previously incorporated by reference.

Devices in accordance with the principles of the present invention can include diesel particulate filters, catalytic converters (e.g., for oxidizing compounds such as carbon monoxide or hydrocarbons, or for reducing compounds such as nitric oxide) and NOx traps. The devices can be mounted in a variety of vehicle exhaust structures such as mufflers, stand-alone catalytic converter shells or other vehicle exhaust conduits.

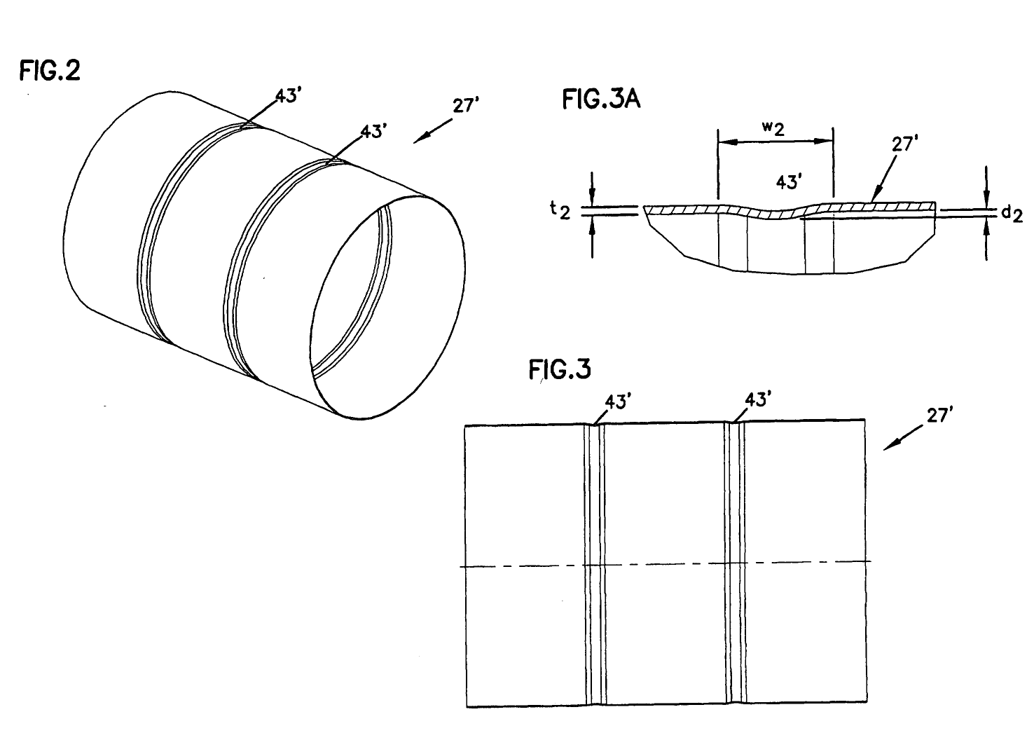

The device 20 is preferably mounted within the vehicle exhaust structure 27 such that the first face 39 of the substrate 22 faces in an upstream direction and the second face 41 faces in a downstream direction. As so mounted, exhaust gases flow through the substrate in a direction traveling from the first face 39 to the second face 41. The device 20 is preferably mounted in a vehicle exhaust structure (e.g., a muffler or catalytic converter shell) by pushing the device 20 into the structure, and then welding the device 20 in place. Preferable, the bead structure 43 provides an interference fit with the vehicle exhaust structure thereby providing a circumferential seal between the vehicle exhaust structure and the device 20. Because the bead 43 contacts the vehicle exhaust structure at only a relatively small contact area, excessive force is not required to press/slide the device 20 into the structure. Further, the size and shape of the outer perimeter can be relatively precisely controlled so as to correspond to the size and shape of the vehicle exhaust structure into which the device 20 is intended to be mounted. In alternative embodiments, the bead 43 can be replaced with a radially inwardly projecting bead formed on the vehicle exhaust structure into which the device 20 is mounted. For example, FIGS. 2, 3 and 3A show a vehicle exhaust structure 27′ including two axially spaced-apart bead structures 43′ that project radially inwardly into the structure 27′. The bead structure 43′ can have a dimension w2 in the range of 0.5-2 or 0.75-1 inch and a dimension d2 that is 0.5 to 2 times as large a thickness T2 of the structure 27′. In other embodiments, the dimension d2 is 0.75 to 1.25 times as large as the thickness t2. In further embodiments, the dimension d2 is in the range of 0.025-0.080 inch, or 0.035-0.060 inch, or about 0.047 inch.

While the various aspects of the present invention are applicable to any type of core device, certain aspects are particularly well suited for cores having relatively brittle substrates such as cores having zeolite substrates or thin-walled substrates (e.g., substrates having wall thicknesses less than 0.005 inches). Conventional techniques for canning cores teach mounting a casing around a substrate, and then subsequently die forming the end flanges to trap the substrate within the core (see U.S. Pat. No. 4,851,015). It has been determined that when a brittle substrate is canned with this type of prior art process, an unacceptably high number of substrates are cracked or otherwise damaged during the canning process. To overcome this problem, the inventors have developed a manufacturing process where the flanges 28 are provided to the casing 24 (e.g., bent, formed or otherwise made) before the substrate 22 is mounted in the casing 24. Because the flanges 28 are not compressed against the substrate, damage to the substrate is reduced. Further, if the shape of the substrate does not exactly match the shape of the pre-made casing (e.g., if the casing is “round” and the substrate is slightly “out of round” as described in the Background), the casing can conform to the shape of the substrate thereby preventing excessive compression loads from being applied to the substrate. Since the substrate itself is not required to be compressed within a die, the cracking problems caused by size mismatches, as described in the Background, can be avoided.

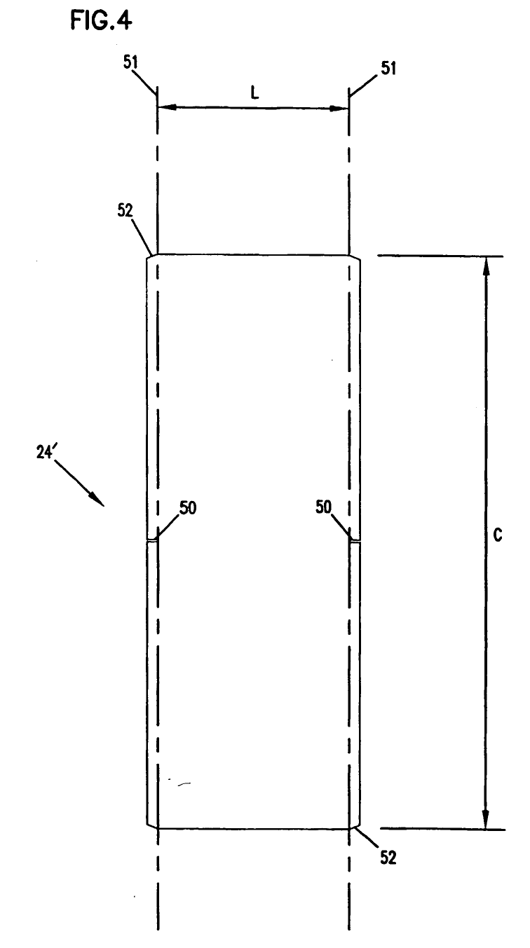

FIGS. 4, 5A and 5B show a sequence of method steps in accordance with the principles of the present invention. At FIG. 4, a precursor casing 24′ is shown. The precursor casing 24′ is representative of the casing 24 before the casing 24 has been formed into the structure shown in FIG. 1. As shown in FIG. 4, the precursor casing 24′ is flat and has a first dimension L that corresponds generally to a distance between upstream and downstream faces 39, 41 of the device 20, and a second dimension C that corresponds to a circumference of the device 20. Notches 50 are defined at opposite ends of the flat casing 24′. The notches 50 are preferably located at a mid-point of the second dimension C and can be made through a punching process. The notches 50 extend inwardly to flange fold lines 51 of the precursor casing 24′. Also, corners 52 of the precursor casing 24′ have been cut-away.

FIGS. 5A and 5B show the precursor casing 24′ in the process of being rolled from a flat sheet (as shown in FIG. 4) into the 3-dimensional structure of FIG. 1 (i.e., the structure that includes primary wall 26 and end flanges 28). As shown in FIGS. 5A and 5B, the precursor casing 24′ is directed between two forming rollers 100 and 102. Roller 100 is preferably made of a relatively hard material (e.g., stainless steel) and roller 102 is preferably made of a softer material such as polyurethane. Roller 102 has a recess 104 for receiving the precursor casing 24′, and end projections 106 for bending the flanges 28 radially inwardly as the precursor casing 24′ passes between the rollers 100, 102. The flanges 28 are preferably bent at fold lines 51. The precursor casing 24′ is wrapped about the roller 100 to provide the primary wall 26 of the casing 24 with an arcuate shape (e.g., a cylindrical shape or an oval shape). The rollers 100, 102 each rotate about their corresponding central axes 100′, 102′.

Referring to FIG. 5B, the roller 100 includes a circumferential projection 108 and the roller 102 includes a corresponding circumferential recess 110. The projection 108 and recess 110 cooperate to form the circumferential bead 43 of the casing 24 as the precursor casing 24′ passes between the rollers 100, 102.

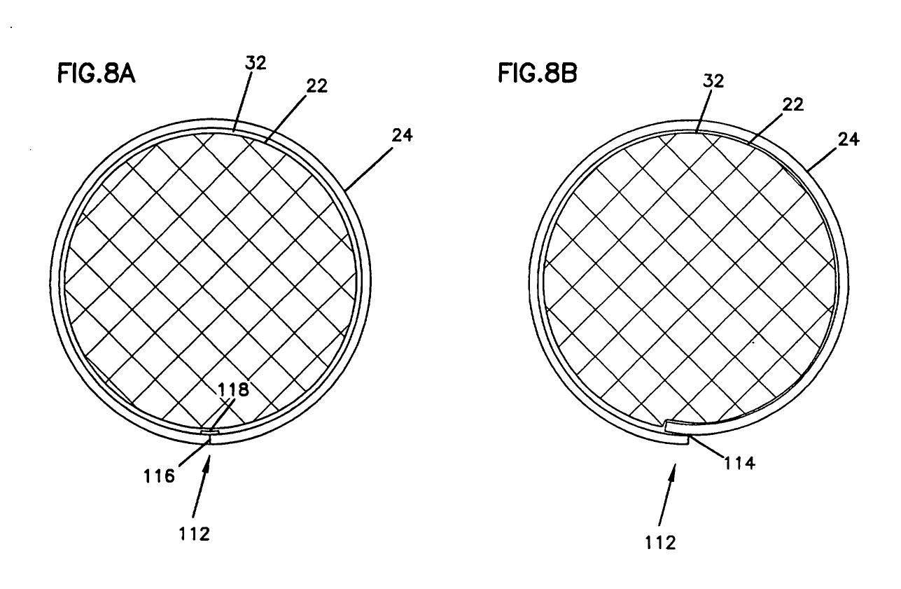

FIG. 6 shows the casing 24 after the forming process has been completed. A shown in FIG. 6, the notches 50 are positioned opposite a seam 112 of the casing 24. The casing 24 can be removed from the roller 100 by flexing the casing 24 at the notches 50 so that the casing opens in a clam-shell type manner with the notches providing a hinge for allowing the casing 24 to be flexed open without resistance from the flanges 28 (see FIG. 7). With the casing 24 open, the substrate 22 is placed in the casing 24. The substrate 22 can be inserted radially into the casing 24 as shown in FIG. 7, or inserted axially into the casing. If the substrate 22 is inserted axially into the casing 24, the casing 24 need only be flexed open an amount sufficient for the openings defined by the flanges 28 to be larger than the substrate 22. Preferably, the cushioning layer 32 and the sealing members 34 are mounted about the substrate 22 before the substrate is mounted in the casing 24. The casing 24 is then closed and the seam 112 is secured with either a welded lap joint 114 (shown in FIG. 8A) or a welded butt joint 116 (shown in FIG. 8B). In the case of the lap joint 114, the cut-away comers 52 assist in enhancing the metal-to-metal contact region at the overlap portion. If cut-away comers 52 are provided at only one end of the casing, the end with the cut-away comers 52 is preferably placed under the end without cut-way corners. In the case of the butt joint 116, a backing piece 118 is placed at the seam 112 to serve as a backing for weld wire and to prevent the cushioning layer 32 from pinching into the seam region.

After the seam 112 has been secured, the casing 24 containing the substrate 22 is heated (e.g., in an oven) to cure and expand the cushioning layer 32. Thereafter, the device 20 can be mounted in a vehicle exhaust structure as described above.

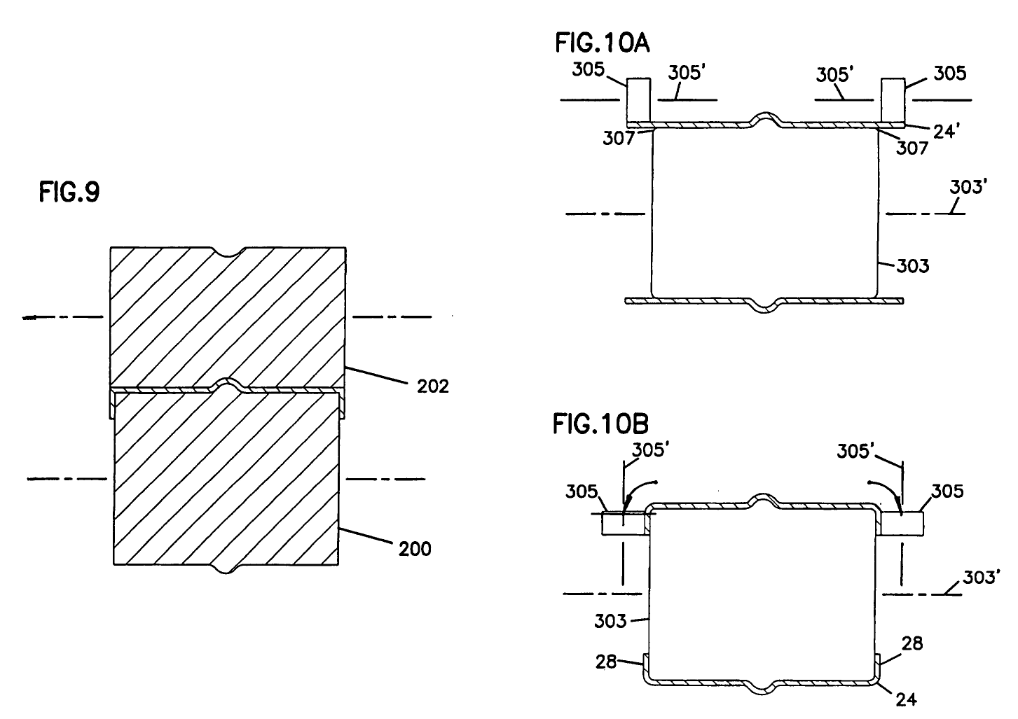

The forming process described above results in the simultaneous forming of the bead 43, the flanges 28 and the curvature of the primary wall 28 of the casing 24. In other embodiments, the various features can be formed or otherwise provided at discrete separate steps. For example, in one embodiment, the bead 43 and the flanges 28 can be formed while the precursor casing 24′ is flat (e.g., with a die forming press). Thereafter, the precursor casing 24′ can be rolled to a curved shape by rollers such as rollers 200 and 202 shown in FIG. 9. The rollers 200, 202 are preferably shaped to prevent the bead 43 and the flanges 28 from being flattened out during the rolling process.

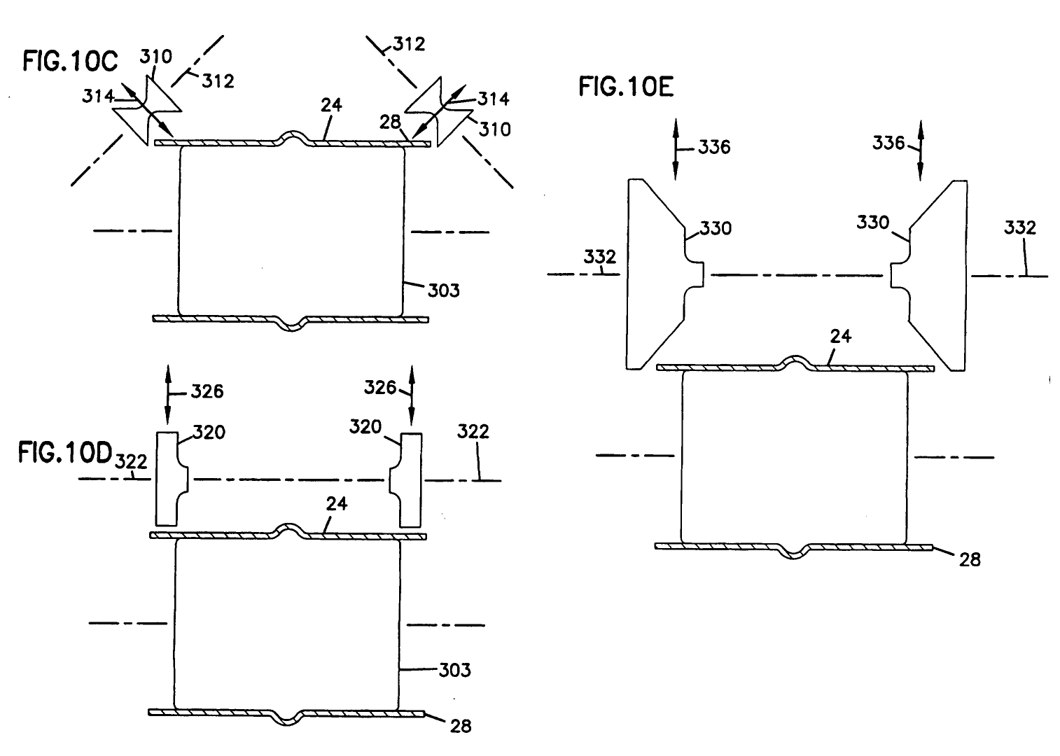

FIGS. 10A and 10B show another process for making the casing 24. In this process, the precursor casing 24′ is first rolled into an arcuate shape (e.g., cylindrical or oval). Next, the rolled precursor casing 24′ is mounted on a spinning mandrel 303 as shown in FIG. 10A. The mandrel 303 rotates about axis 303′. Subsequently, the spinning mandrel is turned about its central axis 303′ and forming rollers 305 are used to bend the flanges 28 radially inwardly. Rollers 305 rotate about axes 305′. The mandrel 303 preferably has rounded ends 307. After bending the flanges 28, the casing 24 can be flexed opened at its hinge to remove the casing from the mandrel 303.

FIG. 10C shows a flange forming configuration including spinning mandrel 303 and concave forming rollers 310. Rollers 310 are free to rotate about axes 312. To bend the end flanges 28 of the casing 24, the rollers 310 can be moved at 45 degree angles (e.g., see paths shown by arrows 314) toward the casing 24.

FIG. 10D shows a flange forming configuration including spinning mandrel 303 and concave forming rollers 320. Rollers 320 are free to rotate about axes 322. To bend the end flanges 28 of the casing 24, the rollers 320 can be moved radially (e.g., see paths shown by arrows 326) toward the casing 24.

FIG. 10E shows a flange forming configuration including spinning mandrel 303 and angled forming rollers 330. Rollers 330 are free to rotate about axes 332. To bend the end flanges 28 of the casing 24, the rollers 330 can be moved radially (e.g., see paths shown by arrows 336) toward the casing 24. In other embodiments, the rollers 330 can be moved in an axial direction (i.e., in a direction parallel to the axis of rotation of the mandrel 303) to bend the flanges 28.

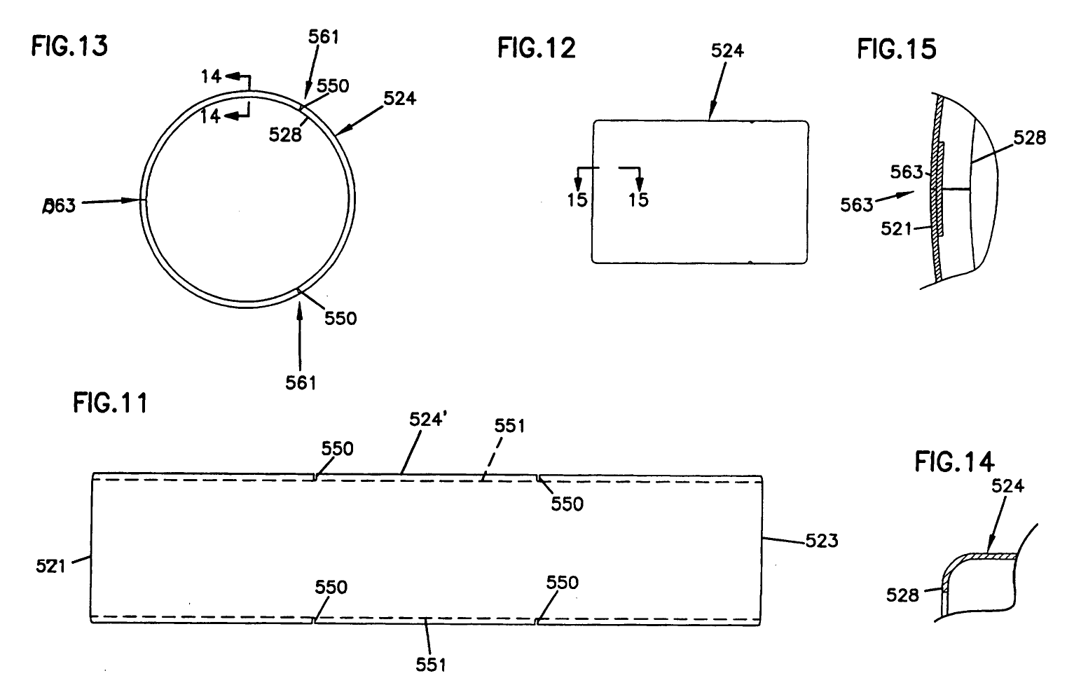

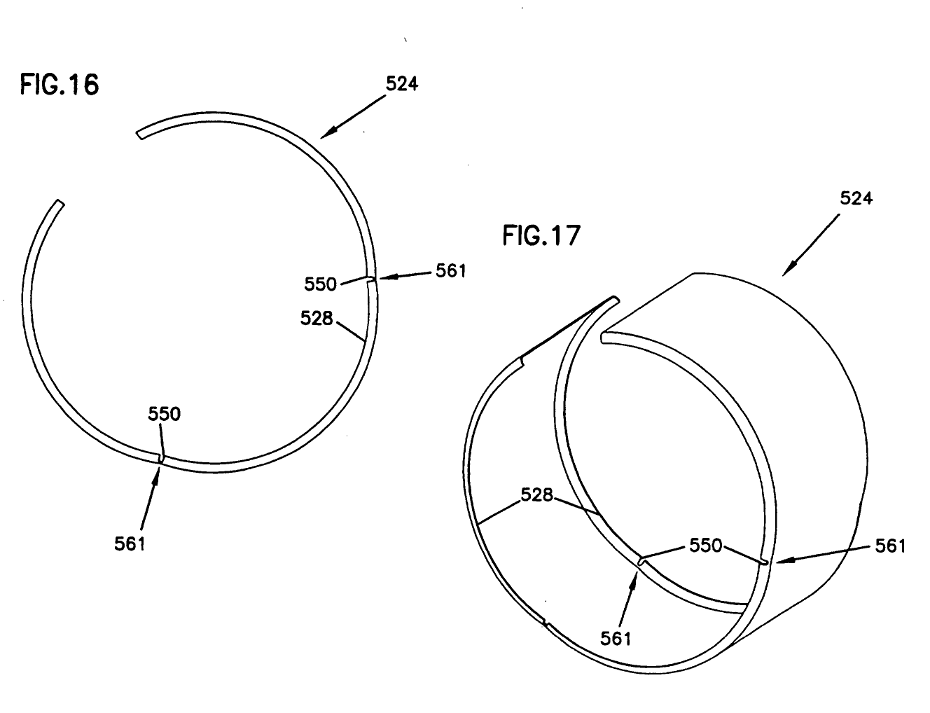

FIG. 11 illustrates a precursor casing 524′ that is bent to form an alternative casing 524 (see FIGS. 12-17) in which a substrate can be mounted. As shown in the laid-flat view of FIG. 11, the precursor casing 524′ includes first and second ends 521 and 523, and fold/bend lines 551 that extend between the ends 521, 523. Two sets of notches 550 are equally spaced along the length of the precursor casing 524′. To manufacture the casing 524, the precursor casing 524′ is bent at lines 551 to form flanges 528 (see FIGS. 13, 14, 16 and 17), and is also rolled or otherwise shaped into a cylindrical configuration (see FIGS. 12, 13 and 17). The casing 524 includes two hinge locations 561 (see FIGS. 13, 16 and 17) defined by notches 550. The hinge locations 561 facilitate flexing the casing 524 open (as shown in FIGS. 16 and 17) to allow a substrate to be inserted therein after formation of flanges 528. Once a substrate is mounted within the casing 524, the ends 521, 523 of the casing 524 can be secured together by means such as a butt joint 563 (see FIG. 15).

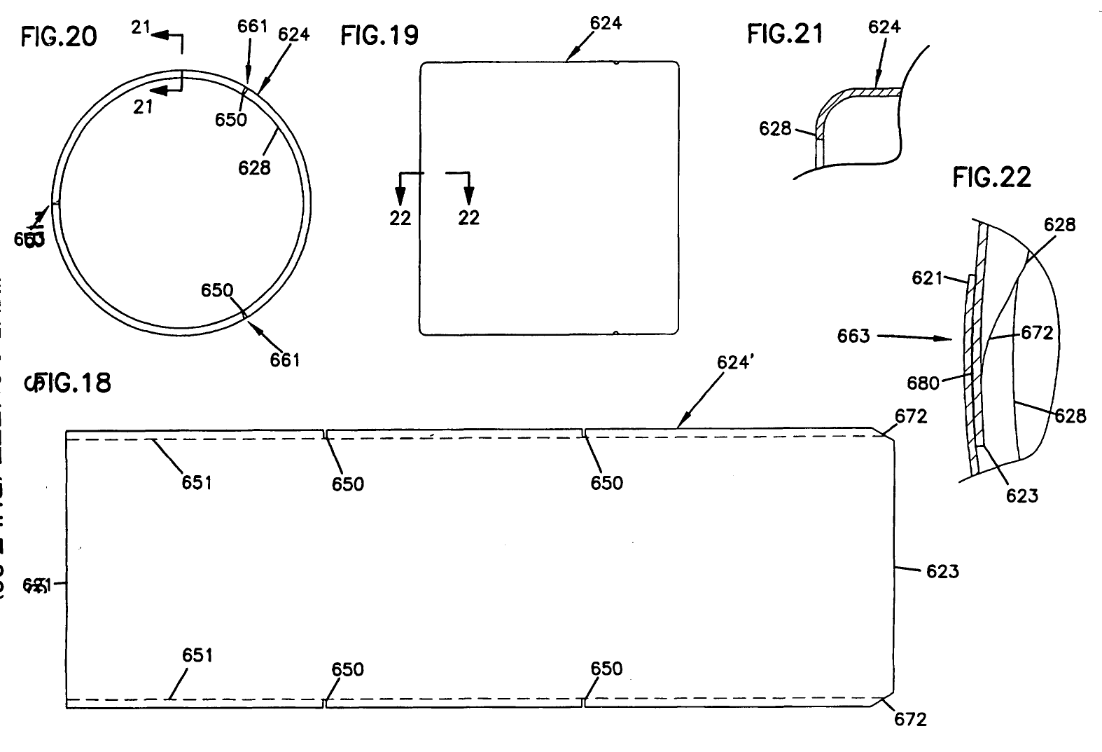

FIG. 18 illustrates a precursor casing 624′ that is bent to form an alternative casing 624 (see FIGS. 19 and 20) in which a substrate can be mounted. As shown in the laid-flat view of FIG. 18, the precursor casing 624′ includes first and second ends 621 and 623, and fold/bend lines 651 that extend between the ends 621, 623. Two sets of notches 650 are equally spaced along the length of the precursor casing 624′. Cut-away regions 672 are located at the second end 623 of the precursor casing 624′ where corners of the precursor casing 624′ have been removed. To manufacture the casing 624, the precursor casing 624′ is bent at lines 651 to form flanges 628 (see FIGS. 20 and 21), and is also rolled or otherwise shaped into a cylindrical configuration (see FIGS. 19 and 20). The casing 624 includes two hinge locations 661 (see FIG. 20) defined by notches 650. The hinge locations 661 facilitate flexing the casing 624 open to allow a substrate to be inserted therein after formation of flanges 628. Once a substrate is mounted within the casing 624, the ends 621, 623 of the casing 624 can be secured together by means such as a lap joint 663 (see FIG. 22). As depicted in FIG. 22, the second end 623 underlies the first end 621 and the cut-away region 672 facilitates providing metal-to-metal contact at region 680.

The above specification and examples provide a complete description of the manufacture and use of the invention. Since many embodiments of the invention can be made without departing from the spirit and scope of the invention, the invention resides in the claims hereinafter appended.

What is claimed is:

1. A method for making an exhaust treatment apparatus including a substrate positioned within a casing, the casing including a primary portion that surrounds the substrate and at least one end flange that extends inwardly from the primary portion, the end flange opposing an end of the substrate, the method comprising:
providing the casing with the end flange; and
positioning the substrate in the casing after the casing has been provided with the end flange.

2. The method of claim 1, wherein the casing is provided with end flanges at opposite ends of the casing, and wherein the substrate is positioned in the casing after both of the end flanges have been provided.

3. The method of claim 2, wherein the casing is expanded to allow the substrate to be inserted therein.

4. The method of claim 3, wherein the casing is expanded by flexing the casing at a hinge location.

5. The method of claim 4, wherein the hinge location is defined by notches in the flanges.

6. The method of claim 3, wherein the casing is expanded at least two hinge locations.

7. The method of claim 3, wherein the casing is closed after the substrate is inserted therein.

8. The method of claim 7, wherein the casing is closed by a lap joint.

9. The method of claim 7, wherein the casing is closed by a butt joint.

10. The method of claim 8, wherein the flanges include cut-away comers adjacent the lap joint.

11. The method of claim 1, wherein the substrate includes zeolite.

12. An exhaust treatment apparatus comprising:
a substrate defining a plurality of channels extending therethrough, the substrate having first and second ends; and
a casing including a primary wall that surrounds the substrate, the casing also including end flanges that extend inwardly from the primary wall and oppose the first and second ends of the substrate, the end flanges including notches defined therein for allowing the casing to be flexed open during manufacture of the exhaust treatment device.

13. The apparatus of claim 12, wherein the substrate includes zeolite.

14. The apparatus of claim 12, wherein the casing includes a circumferential bead structure that projects outwardly from the primary wall.

15. The apparatus of claim 14, wherein the bead structure includes a continuous bead that extends about a circumference of the casing.

16. The apparatus of claim 14, wherein the casing has a thickness, and the bead structure has a radial dimension in the range of 0.5-2 times the thickness of the casing.

17. The apparatus of claim 14, wherein the bead structure has a width in the range of 0.5-2 inches.

18. The apparatus of claim 12, wherein the flanges include at least two sets of notches that define at least two hinge locations.

19. The apparatus of claim 12, wherein the casing includes a butt joint.

20. The apparatus of claim 12, wherein the casing includes a lap joint.

21. The apparatus of claim 20, wherein the flanges include cut-away corners adjacent the lap joint.

22. An exhaust treatment apparatus comprising:
a substrate defining a plurality of channels extending therethrough, the substrate having first and second ends; and
a casing including a primary wall that surrounds the substrate;
a vehicle exhaust structure in which the casing is mounted;
a bead structure extends circumferentially about the apparatus between the primary wall and the vehicle exhaust structure.

23. The apparatus of claim 22, wherein the bead structure includes a continuous bead that extends about the circumference of the bead structure to form a seal between the casing and the vehicle exhaust structure.

24. The apparatus of claim 22, wherein the bead structure is integral with the casing.

25. The apparatus of claim 22, wherein the bead structure is integral with the vehicle exhaust structure.

26. The apparatus of claim 22, wherein the casing has a thickness, and the bead structure has a radial dimension in the range of 0.5-2 times the thickness of the casing.

27. The apparatus of claim 22, wherein the bead structure has a width in the range of 0.5-2 inches.
